(19) United States
(12) Patent Application Publication
(10) Pub. No.: US 2026/0286868 A1
(43) Pub. Date: Sep. 24, 2026

(54) STEAM SUPPLY SYSTEM AND STEAM SUPPLY METHOD

(71) Applicant: MITSUBISHI HEAVY INDUSTRIES, LTD., Tokyo (JP)

(72) Inventors: Kazushige Takaki, Tokyo (JP); Makoto Kishi, Tokyo (JP); Takashi Sonoda, Tokyo (JP); Yosuke Nakagawa, Tokyo (JP)

(73) Assignee: MITSUBISHI HEAVY INDUSTRIES, LTD., Tokyo (JP)

(21) Appl. No.: 19/137,937

(22) PCT Filed: Aug. 24, 2023
(86) PCT No.: PCT/JP2023/030533

§ 371 Date: Jun. 11, 2025

(30) Foreign Application Priority Data
Jan. 31, 2023 (JP) 2023-012809

(51) Int. Cl. F01K 23/10; F01K 13/02

(52) U.S. Cl. CPC F01K 23/108; F01K 13/02; F05D 2260/85; F05D 2270/301; F05D 2270/65

(57) ABSTRACT

A steam supply system that supplies steam generated in a heat recovery steam generator to a CO₂ capture plant that captures CO₂ from exhaust gas discharged from a power generation plant including a gas turbine, the heat recovery steam generator, and a steam turbine, including: a first system that supplies intermediate-pressure steam generated in the heat recovery steam generator to the CO₂ capture plant; a second system that bleeds a part of low-pressure steam from a low-pressure system that supplies the low-pressure steam from the heat recovery steam generator to the steam turbine and supplies the part of the low-pressure steam to the CO₂ capture plant; and a control device that performs control to supply the steam to the CO₂ capture plant through the first system during startup of the power generation plant.

### TECHNICAL FIELD

The present disclosure relates to a steam supply system and a steam supply method for supplying steam to a CO₂ capture plant. The present disclosure claims priority based on Japanese Patent Application No. 2023-012809, filed in Japan on Jan. 31, 2023, the content of which is integrated herein by reference.

### BACKGROUND ART

A plant in which a CO₂ capture plant is combined with a gas turbine combined cycle (GTCC) has been provided. PTL 1 discloses a configuration in which, in the plant in which a GTCC and a CO₂ capture plant are combined, an auxiliary heat exchanger for a CO₂ capture plant is prepared separately from a heat exchanger for a steam turbine, and steam necessary for the CO₂ capture plant is supplied. In this configuration, it is necessary to review a heat exchange design in an HRSG. PTL 2 discloses a configuration in which a plant in which a steam turbine and a CO₂ capture plant are combined includes a pipe that guides steam for driving a high-pressure turbine to a low-pressure turbine, and an air bleeding pipe that branches from the pipe and guides a part of the steam for driving the high-pressure turbine to the CO₂ capture plant. It is considered that when this configuration is applied to the plant in which the GTCC and the CO₂ capture plant are combined, it is possible to combine the CO₂ capture plant with the existing GTCC configuration without greatly changing the configuration.

### CITATION LIST

### Patent Literature

[PTL 1] International Publication No. WO2019/208416
[PTL 2] Japanese Patent No. 5968176

### SUMMARY OF INVENTION

### Technical Problem

In a case where the GTCC is operated under a rated load, the CO₂ capture plant can be operated to achieve a target capture rate of CO₂ by supplying a part of the steam for driving the steam turbine to the CO₂ capture plant. However, since a sufficient amount of steam is not generated during GTCC startup, steam cannot be supplied to the CO₂ capture plant, and there is a possibility that the CO₂ capture rate decreases. Although it is conceivable to provide an auxiliary boiler or the like to temporarily generate steam separately in a case where steam is insufficient, such as during plant startup, there are still problems in terms of cost, for example.

The present disclosure provides a steam supply system and a steam supply method capable of solving the above-described problems.

### Solution to Problem

According to the present disclosure, there is provided a steam supply system that supplies steam generated in a heat recovery steam generator to a CO₂ capture plant that captures CO₂ from exhaust gas discharged from a power generation plant including a gas turbine, the heat recovery steam generator, and a steam turbine, the steam supply system including a first system that supplies intermediate-pressure steam generated in the heat recovery steam generator to the CO₂ capture plant; a second system that bleeds a part of low-pressure steam from a low-pressure system that supplies the low-pressure steam from the heat recovery steam generator to the steam turbine and supplies the part of the low-pressure steam to the CO₂ capture plant; and a control device that performs control to supply the steam to the CO₂ capture plant through the first system during startup of the power generation plant.

According to the present disclosure, there is provided a steam supply method including supplying intermediate-pressure steam generated in a heat recovery steam generator to a CO₂ capture plant that captures CO₂ from exhaust gas discharged from a power generation plant including a gas turbine, the heat recovery steam generator, and a steam turbine, during startup of the power generation plant, in a plant that includes the power generation plant and the CO₂ capture plant.

### Advantageous Effects of Invention

According to the steam supply system and the steam supply method described above, in the plant in which the GTCC and the CO₂ capture plant are combined, it is possible to supply sufficient steam to the CO₂ capture plant even during the GTCC startup.

### BRIEF DESCRIPTION OF DRAWINGS

FIG. 1 is a schematic diagram of a plant according to each embodiment.

FIG. 2 is a first view showing an example of a main part of a plant configuration according to a first embodiment.

FIG. 3 is a second view showing an example of the main part of the plant configuration according to the first embodiment.

FIG. 4 is a diagram showing an example of a transition of state quantities of a GTCC and a CO₂ capture plant during plant startup according to the first embodiment.

FIG. 5 is a time chart showing an example of switching control of a steam supply system according to a second embodiment.

FIG. 6 is a flowchart showing an example of switching control of a steam supply system according to the second embodiment.

FIG. 7 is a flowchart showing an example of switching control of a steam supply system according to a third embodiment.

FIG. 8 is a flowchart showing an example of switching control of a steam supply system according to a fourth embodiment.

FIG. 9 is a diagram showing an example of a main part of a plant configuration according to a fifth embodiment.

FIG. 10 is a diagram showing an example of a hardware configuration of a control device according to each embodiment.

### DESCRIPTION OF EMBODIMENTS

### Overview

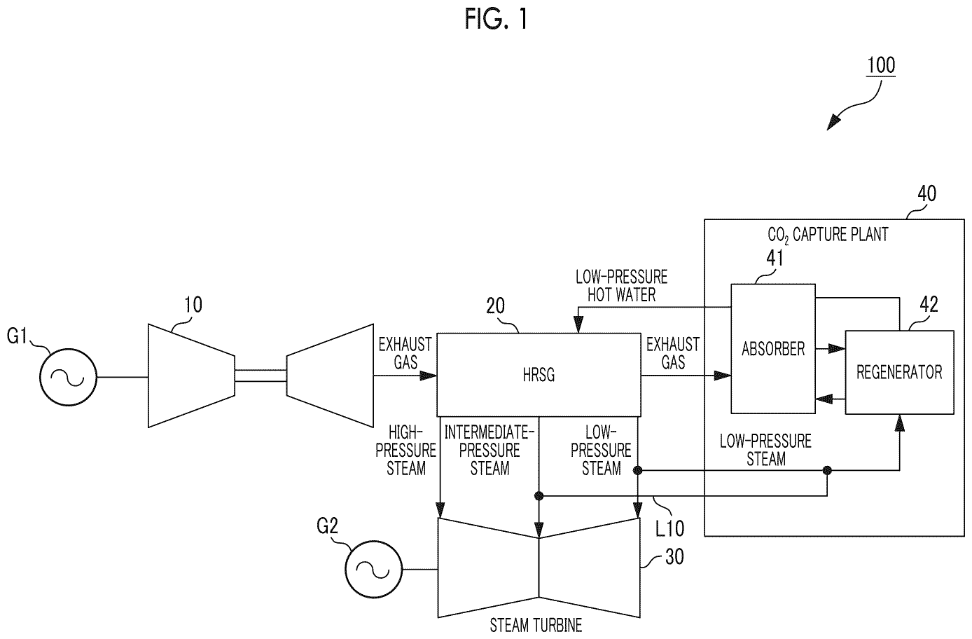

Hereinafter, a steam supply control for a CO₂ capture plant according to the present disclosure will be described with reference to FIGS. 1 to 10.

FIG. 1 shows a schematic configuration of a plant in which a GTCC (combined cycle power generation plant) and a CO₂ capture plant are combined. A plant 100 includes a gas turbine 10, a heat recovery steam generator (HRSG) 20, a steam turbine 30, a CO₂ capture plant 40, generators G1 and G2, and a control device 50. The gas turbine 10 is connected with a generator G1 and drives the generator G1. The steam turbine 30 is connected with a generator G2 and drives the generator G2. Exhaust gas discharged from the gas turbine 10 is sent to the HRSG 20, and after being used in the HRSG 20, is sent to the CO₂ capture plant 40. The HRSG 20 recovers heat from the exhaust gas, generates high-pressure steam, intermediate-pressure steam, and low-pressure steam, supplies the steam to the steam turbine 30, and supplies the low-pressure steam to a regenerator 42 of the CO₂ capture plant 40. The HRSG 20 sends the exhaust gas after heat recovery to the CO₂ capture plant 40. The CO₂ capture plant 40 includes an absorber 41 and the regenerator 42, and extracts CO₂ from the exhaust gas sent from the HRSG 20 by circulating an absorption liquid between the absorber 41 and the regenerator 42. In the extraction of CO₂, steam is required as a heat source, but in the plant 100, low-pressure steam supplied from the HRSG 20 is used as the heat source. The low-pressure steam used in the process of CO₂ extraction is condensed to become low-pressure hot water, and the generated low-pressure hot water is supplied from the CO₂ capture plant 40 to the HRSG 20. In such a configuration, the steam cannot be supplied to the CO₂ capture plant 40 until a sufficient amount of low-pressure steam is generated in the HRSG 20 after the GTCC startup. Therefore, in the present embodiment, a startup intermediate-pressure bleed system L10 that bleeds a part of intermediate-pressure steam from the HRSG 20 and supplies the part of the intermediate-pressure steam to the CO₂ capture plant 40, and a control device 50 that performs control for switching, with respect to the supply of steam to the CO₂ capture plant 40, between a system that supplies low-pressure steam to the CO₂ capture plant 40 and the startup intermediate-pressure bleed system L10 are provided, and during the GTCC startup, a part of the intermediate-pressure steam, in which a sufficient amount of steam is generated earlier than in the low-pressure steam, is controlled to be supplied to the CO₂ capture plant 40 through startup intermediate-pressure bleed system L10. In this manner, it is possible to supply the steam to the CO₂ capture plant 40 even during the GTCC startup.

### First Embodiment

### Configuration

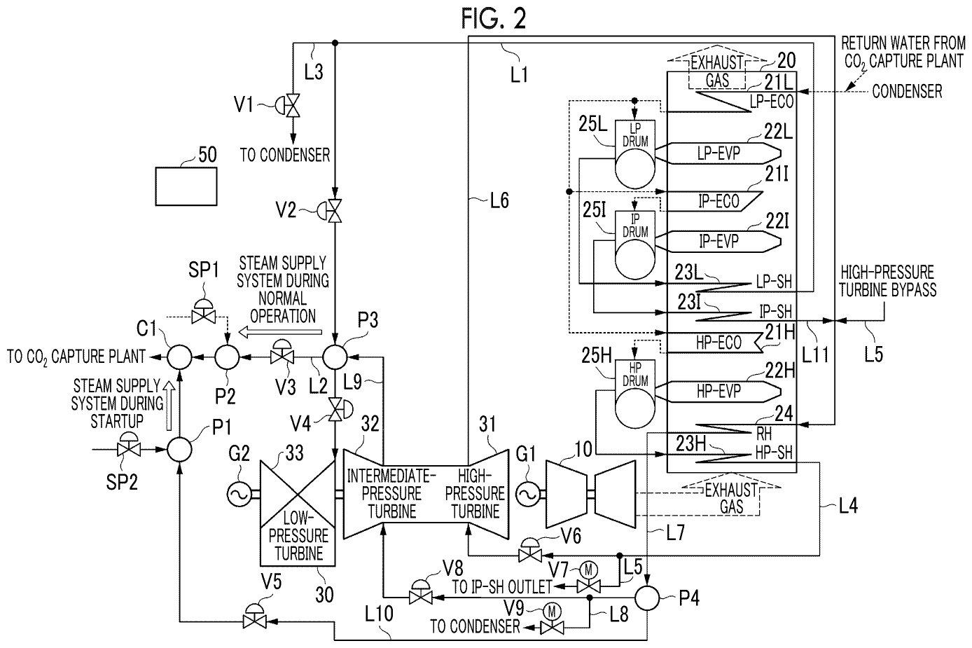

FIG. 2 is a first view showing an example of a main part of a plant configuration according to the first embodiment. The HRSG 20 provided in a rear stage of the gas turbine 10 includes a low-pressure economizer 21L, an intermediate-pressure economizer 21I, a high-pressure economizer 21H, a low-pressure evaporator 22L, an intermediate-pressure evaporator 221, a high-pressure evaporator 22H, a low-pressure superheater 23L, an intermediate-pressure superheater 23I, a high-pressure superheater 23H, a reheater 24, a low-pressure drum 25L, an intermediate-pressure drum 25I, and a high-pressure drum 25H. The steam turbine 30 includes a high-pressure turbine 31, an intermediate-pressure turbine 32, and a low-pressure turbine 33. Low-pressure steam is supplied from the low-pressure superheater 23L to the low-pressure turbine 33 through a system L1. A system L2 leading to the CO₂ capture plant 40 is connected to the system L1, and a part of the low-pressure steam supplied from the low-pressure superheater 23L is branched and supplied to the CO₂ capture plant 40 (regenerator 42) through the system L2. Further, on an upstream side of a branching point between the system L1 and the system L2 (upstream side in a steam flow direction, hereinafter, simply referred to as an upstream side and a downstream side), a system L3 branching from the system L1 is provided, and a low-pressure turbine bypass valve V1 is provided in the system L3. During a time period in which an amount of low-pressure steam generated during plant startup is small, a low-pressure turbine bypass valve V1 is open, and the low-pressure steam bypasses the low-pressure turbine 33 and is sent to a condenser (not shown) through the system L3. A pressure gauge P3 is provided at the branching point between the system L1 and the system L2, and a low-pressure steam governing valve V2 is provided on the upstream side of the branching point where the pressure gauge P3 is provided in the system L1, and a CCP inlet pressure regulating valve V4 is provided on a downstream side (CCP indicates a CO₂ capture plant). A pressure gauge P2 that measures the pressure of the low-pressure steam supplied to the CO₂ capture plant 40 is provided on a downstream side of the system L2, and a low-pressure steam bleed valve V3 is provided between the pressure gauge P2 and the pressure gauge P3 in the system L2. For example, a temperature-reducing spray SP1 for adjusting (cooling) a temperature of the low-pressure steam to an appropriate temperature is provided in the vicinity of the position where the pressure gauge P2 is provided.

The high-pressure steam is supplied from the high-pressure superheater 23H to the high-pressure turbine 31 through a system L4. A high-pressure main steam governing valve V6 that regulates a flow rate of the high-pressure steam is provided in the system L4. A system L5 is connected to the system L4, and a high-pressure turbine bypass valve V7 is provided in the system L5. When the high-pressure turbine bypass valve V7 is open, the high-pressure steam bypasses the high-pressure turbine 31 and flows to an outlet side of the intermediate-pressure superheater 231 through the system L5. The high-pressure steam supplied to the high-pressure turbine 31 is returned to the reheater 24 through a system L6. The system L6 is a system in which the system L5 and a system L11 on the outlet side of the intermediate-pressure superheater 23I merge.

Intermediate-pressure steam is supplied from the reheater 24 to the intermediate-pressure turbine 32 through a system L7. The pipe L7 is provided with an intermediate-pressure steam governing valve V8 that regulates a flow rate of the intermediate-pressure steam. A system L8 is connected to the system L7, and an intermediate-pressure turbine bypass valve V9 is provided in the system L8. When the intermediate-pressure turbine bypass valve V9 is open, the intermediate-pressure steam bypasses the intermediate-pressure turbine 32 and flows to a condenser (not shown) through the system L8. The intermediate-pressure steam supplied to the intermediate-pressure turbine 32 is guided to a position where the pressure gauge P3 of the system L1 is provided through a system L9 (crossover pipe), and merges with the low-pressure steam supplied to the low-pressure turbine 33 or the CO₂ capture plant 40. A pressure gauge P4 is provided on the upstream side of the branching point between the system L7 and the system L8. At a position where the pressure gauge P4 is provided, a startup intermediate-pressure bleed system L10 that leads to the system L2 that is a steam supply system to the CO₂ capture plant 40 is connected. The startup intermediate-pressure bleed system L10 is provided with a startup intermediate-pressure steam pressure reducing valve V5, and the startup intermediate-pressure bleed system L10 is a system provided to supply steam to the CO₂ capture plant 40 during the GTCC startup. A pressure gauge P1 is provided on a downstream side of the startup intermediate-pressure steam pressure reducing valve V5 in the startup intermediate-pressure bleed system L10. A temperature-reducing spray SP2 for adjusting (cooling) a temperature of the intermediate-pressure steam to an appropriate temperature is provided in the vicinity of the position where the pressure gauge P1 is provided. The startup intermediate-pressure bleed system L10 is connected to the system L2 at a supply unit C1. The steam generated by the HRSG 20 is supplied to the CO₂ capture plant 40 through the supply unit C1.

The control device 50 acquires values measured by the pressure gauges P1 to P4 and controls opening degrees of the low-pressure turbine bypass valve V1, the low-pressure steam governing valve V2, the low-pressure steam bleed valve V3, the CCP inlet pressure regulating valve V4, the startup intermediate-pressure steam pressure reducing valve V5, the high-pressure main steam governing valve V6, the high-pressure turbine bypass valve V7, the intermediate-pressure steam governing valve V8, and the intermediate-pressure turbine bypass valve V9.

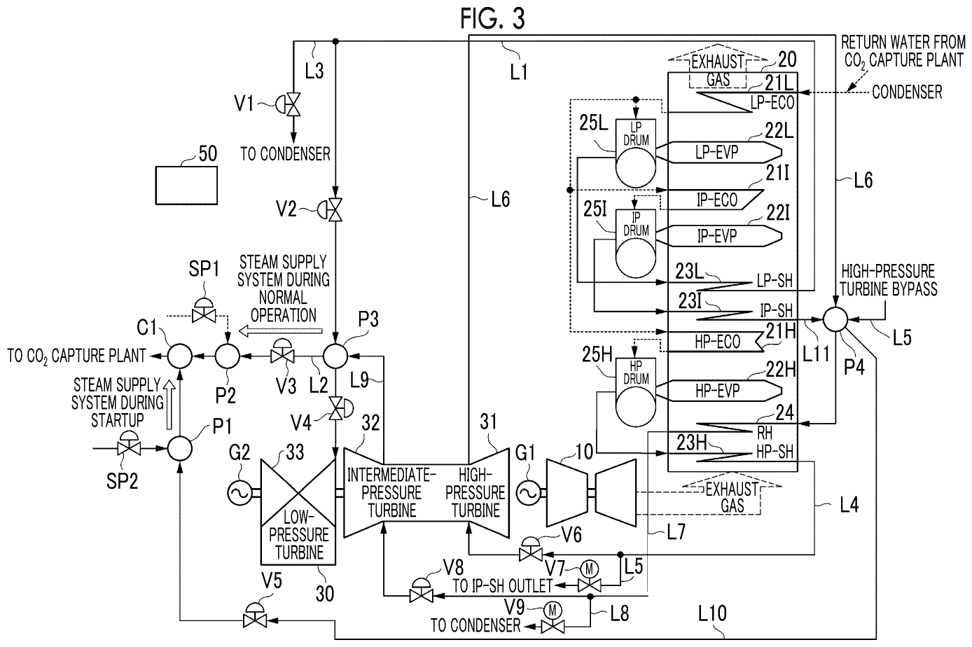

In the configuration example shown in FIG. 2, an example in which the startup intermediate-pressure bleed system L10 is provided so as to connect the outlet of the reheater 24 and the system L2, which is a steam supply system to the CO₂ capture plant 40, is shown. As shown in FIG. 3, the startup intermediate-pressure bleed system L10 can also be provided so as to connect the outlet side of the intermediate-pressure superheater 231 and the system L2.

FIG. 3 is a second view showing an example of a main part of a plant configuration according to the first embodiment. In the configuration example shown in FIG. 3, the pressure gauge P4 is provided at the merging point of the system L11 (output system of the intermediate-pressure steam generated in the intermediate-pressure drum 25I) on the outlet side of the intermediate-pressure superheater 231, the system L5, and the system L6, instead of the system L7 that supplies the intermediate-pressure steam to the intermediate-pressure turbine 32. The startup intermediate-pressure bleed system L10 is provided such that the merging point and the system L2 are connected to each other at the supply unit C1.

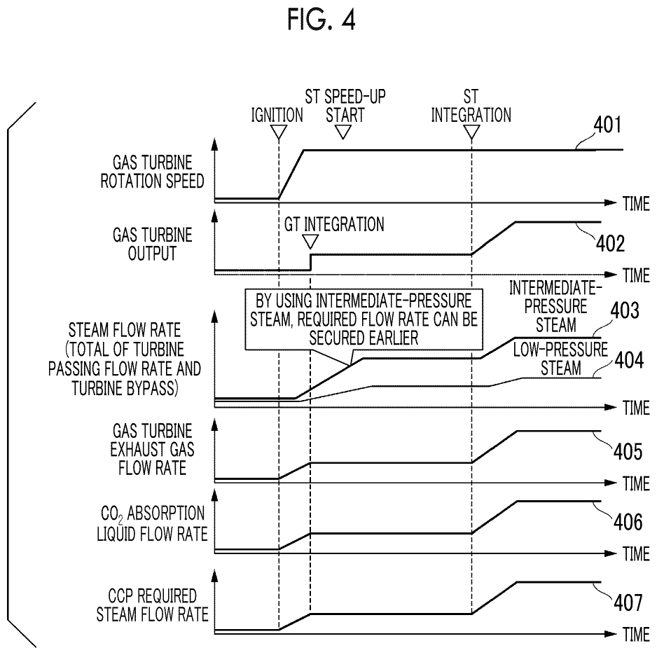

As described above, during the GTCC startup, steam sufficient to be supplied to the CO₂ capture plant 40 is not generated, and there is a possibility that the CO₂ capture rate decreases. As shown in a graph 404 of FIG. 4, it takes time to ensure a sufficient steam flow rate for the low-pressure steam after the GTCC startup. Therefore, in the related art, the intermediate-pressure steam that is released to the outside of the system via a condenser (not shown) by a turbine bypass during the GTCC startup is supplied to the CO₂ capture plant 40 through the startup intermediate-pressure bleed system L10. In this manner, the steam flow rate supplied to the CO₂ capture plant 40 during the GTCC startup is ensured. As shown in a graph 403 of FIG. 4, in the case of the intermediate-pressure steam, a sufficient amount of steam is generated in the HRSG 20 earlier than in the case of the low-pressure steam. By supplying this to the CO₂ capture plant 40, it is expected that the CO₂ capture rate during the GTCC startup can be improved. Since the startup intermediate-pressure bleed system L10 shown in FIGS. 2 and 3 is a modification in which a pipe system is added to the outside of the heat exchanger of the HRSG 20, it is not necessary to change the design of the HRSG 20 itself, and it is possible to prevent an increase in the design cost or the manufacturing cost of the HRSG 20.

FIG. 4 is a diagram showing an example of a transition of state quantities of a GTCC and a CO₂ capture plant during plant startup. The vertical axis of each graph in FIG. 4 represents the magnitude of each state quantity, and the horizontal axis represents time. The same position on the horizontal axis represents the same time. A graph 401 shows a transition of the rotation speed of the gas turbine 10. When ignition is performed on the gas turbine 10 and the GTCC is started, the rotation speed of the gas turbine 10 increases. A graph 402 shows a transition of the output of the gas turbine 10. When the rotation speed of the gas turbine 10 reaches a predetermined value, the gas turbine 10 is connected to the generator GI (integrated). In integration with the gas turbine 10, the generator G1 is driven, thereby increasing the output. Thereafter, as the steam is generated in the HRSG 20, when the rotation speed of the steam turbine 30 increases and the steam turbine 30 is connected (integrated) with the generator G2, the output of the gas turbine 10 and the steam turbine 30 is further increased. The graph 403 shows a transition of the low-pressure steam flow rate, and the graph 404 shows a transition of the intermediate-pressure steam flow rate. As shown in the drawing, after the ignition of the gas turbine 10, the low-pressure steam flow rate and the intermediate-pressure steam flow rate start to increase after a while, but the intermediate-pressure steam flow rate increases faster than the low-pressure steam flow rate. By utilizing this property, the intermediate-pressure steam is supplied to the CO₂ capture plant 40 through the startup intermediate-pressure bleed system L10, so that the required flow rate can be ensured at an early stage after the GTCC startup in the CO₂ capture plant 40. A graph 405 shows a transition of the exhaust gas flow rate discharged by the gas turbine 10. A graph 406 shows a transition of the flow rate of the absorption liquid in the CO₂ capture plant 40, and a graph 407 shows a transition of the required steam flow rate in the CO₂ capture plant 40. The exhaust gas flow rate also increases as the output of the gas turbine 10 increases. The flow rate of the absorption liquid and the required amount of steam increase as the flow rate of the exhaust gas from the gas turbine 10 increases.

### Outline of Control Method

During the GTCC startup, intermediate-pressure steam is bled from the reheater 24 (configuration in FIG. 2) or the outlet side of the intermediate-pressure superheater 23I (configuration in FIG. 3) by opening the startup intermediate-pressure steam pressure reducing valve V5 provided in the startup intermediate-pressure bleed system L10, and is supplied to the CO₂ capture plant 40. On the other hand, after the GTCC startup is completed, the startup intermediate-pressure steam pressure reducing valve V5 is closed, the startup intermediate-pressure bleed system L10 is not used, and instead of the startup intermediate-pressure bleed system L10, the low-pressure steam is supplied to the system L2 through the system L1, and the low-pressure steam is supplied to the CO₂ capture plant 40. Since the low-pressure steam needs to be supplied to the CO₂ capture plant 40, the pressure of the intermediate-pressure steam in the startup intermediate-pressure bleed system L10 is reduced to the low pressure by regulating the opening degree of the startup intermediate-pressure steam pressure reducing valve V5 during the GTCC startup. For example, a target value (a constant pressure as an example) of the pressure of the steam supplied to the CO₂ capture plant 40 is set, and the opening degree of the startup intermediate-pressure steam pressure reducing valve V5 is feedback-controlled such that the pressure measured by the pressure gauge P1 becomes the target value. Since the intermediate-pressure steam is a relatively high temperature, the temperature is reduced by spraying water from the temperature-reducing spray SP2 just before the intermediate-pressure steam reaches the supply unit C1 for the CO₂ capture plant 40, and the intermediate-pressure steam is merged with the supply unit C1. After the GTCC startup is completed and the low-pressure steam bleed system (the low-pressure steam bleed system refers to a system that bleeds low-pressure steam from the system L1 and supplies the steam to the CO₂ capture plant 40 through the system L2) is switched, by regulating the opening degree of the CCP inlet pressure regulating valve V4 provided on the inlet side of the low-pressure turbine 33, the pressure of the steam supplied to the system L2 is kept at the target value and the CO₂ capture plant 40 can stably capture the CO₂. Details of the control for switching between the startup intermediate-pressure bleed system L10 and the low-pressure steam bleed system will be described in the second embodiment to the fourth embodiment.

### Effects

As described above, the startup intermediate-pressure bleed system L10 is provided, and during the GTCC startup, the steam is supplied to the CO₂ capture plant 40 through the startup intermediate-pressure bleed system L10. In this manner, the amount of steam required for CO₂ capture can be ensured. Accordingly, in the CO₂ capture plant 40, the capture rate of CO₂ can be maintained high even during the GTCC startup. In the GTCC in the related art, there is a case where the auxiliary boiler itself is provided. However, it is not necessary to increase the capacity of the auxiliary boiler for the CO₂ capture plant 40. Regarding the provision of the startup intermediate-pressure bleed system L10, the HRSG 20 may have the same design as in the case of the GTCC single plant, and an increase in the design cost or the manufacturing cost can be suppressed.

### Second Embodiment

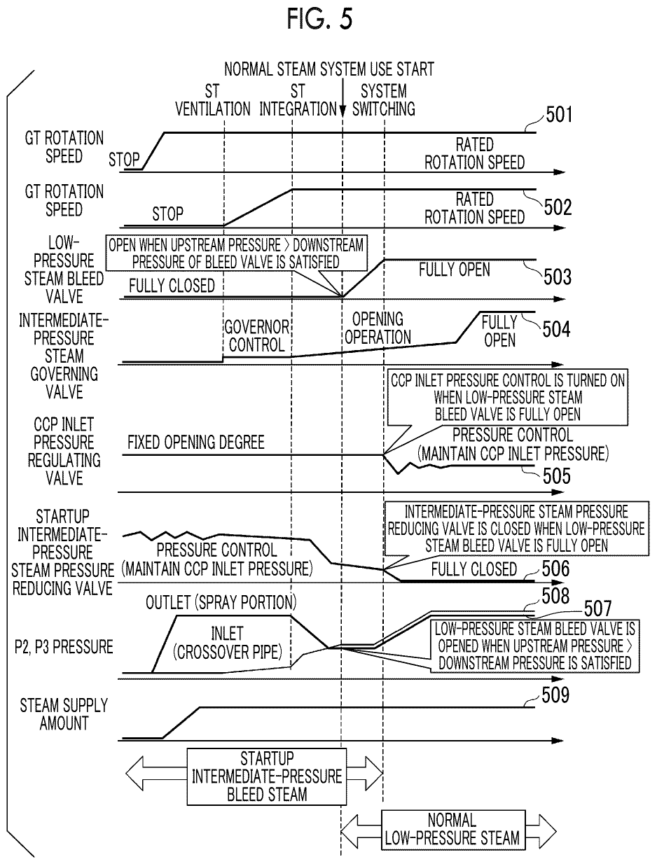

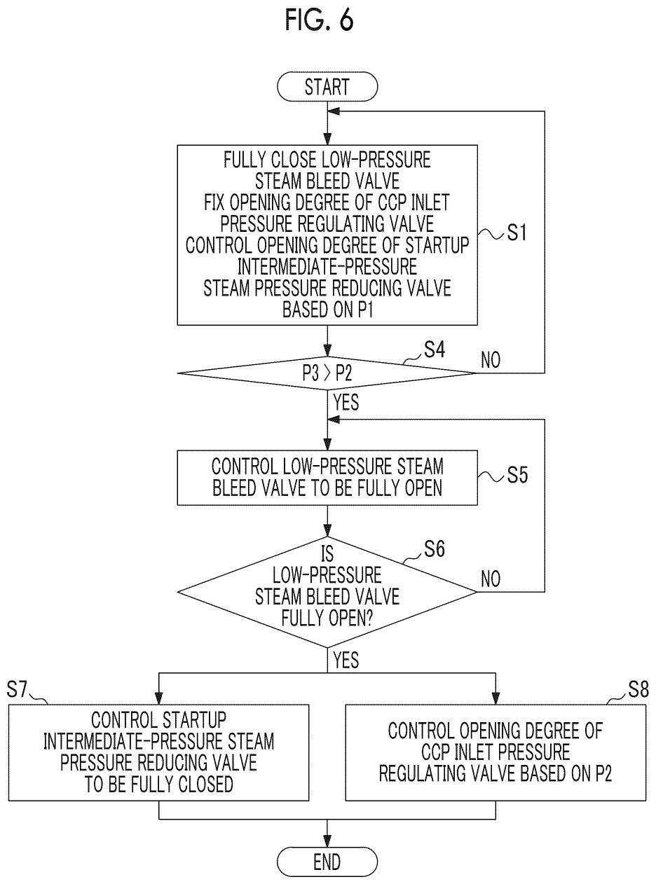

In the second embodiment, an example of control for switching between the startup intermediate-pressure bleed system L10 which is used during the startup and the low-pressure steam bleed system which is used during normal operation will be described with reference to FIGS. 5 and 6. FIG. 5 shows an example of a time chart of a state quantity or a valve opening degree related to the switching control of the steam supply system. The vertical axis of each graph in FIG. 5 represents the magnitude of each state quantity or valve opening degree, and the horizontal axis represents time. The same position on the horizontal axis represents the same time. During the GTCC startup, each event of ST ventilation, ST integration, start of use of a normal steam system, and system switching occurs. The ST ventilation is to close the low-pressure turbine bypass valve V1, the intermediate-pressure turbine bypass valve V9, and the high-pressure turbine bypass valve V7 and to start the supply of the low-pressure steam, the intermediate-pressure steam, and the high-pressure steam generated in the HRSG 20 to the steam turbine 30. The ST integration is to connect the steam turbine to the generator G2. The start of use of the normal steam system means that the supply of the low-pressure steam from the low-pressure steam bleed system to the CO₂ capture plant 40 is started. As described below, there is a period in which both systems are used together from the startup intermediate-pressure bleed system L10 to the low-pressure steam bleed system until complete switching. The system switching is to completely switch from the startup intermediate-pressure bleed system L10 to the low-pressure steam bleed system by fully opening the low-pressure steam bleed valve V3.

A graph 501 shows a transition of the rotation speed (GT rotation speed) of the gas turbine 10, and a graph 502 shows a transition of the rotation speed (ST rotation speed) of the steam turbine 30. As shown in the drawing, the steam turbine 30 is started with a delay after the gas turbine 10, and the rotation speed of the steam turbine 30 gradually increases due to the ST ventilation. When the rotation speed of the steam turbine 30 reaches a predetermined value, the ST integration is performed. A graph 503 shows a transition of the opening degree of the low-pressure steam bleed valve V3. The low-pressure steam bleed valve V3 is fully closed before the start of use of the normal steam system, and is controlled to increase the opening degree at the timing of the start of use of the normal steam system, and to be fully open at the timing of system switching. A graph 504 shows a transition of the opening degree of the intermediate-pressure steam governing valve V8. The intermediate-pressure steam governing valve V8 is open at the timing of the ST ventilation, and then is gradually open and eventually fully open. A graph 505 shows a transition of the opening degree of the CCP inlet pressure regulating valve V4. The CCP inlet pressure regulating valve V4 is fixed at a constant opening degree until the system switching is performed. For example, the opening degree of the CCP inlet pressure regulating valve V4 is set to be fully open or partially open so that the steam can flow to the low-pressure turbine 33. After the system switching, the control device 50 controls the opening degree of the CCP inlet pressure regulating valve V4 such that the pressure measured by the pressure gauge P2 becomes constant (target value). A graph 506 shows a transition of the opening degree of the startup intermediate-pressure steam governing valve V5. From immediately after the GTCC startup to the ST integration, the low-pressure turbine bypass valve V1 is open to bypass the low-pressure steam, and since the steam governing valve V2 is not sufficiently open, the steam of the low-pressure system V1 cannot be used. Therefore, the low-pressure steam bleed valve V3 is in a fully closed state (graph 503), and the startup intermediate-pressure steam governing valve V5 is open to supply all the steam to be supplied to the CO₂ capture plant 40 through the startup intermediate-pressure bleed system L10. The opening degree of the startup intermediate-pressure steam governing valve V5 is controlled such that the pressure measured by the pressure gauge P1 is constant until the system switching is performed, and the startup intermediate-pressure steam governing valve V5 is fully closed after the system switching. The control device 50 regulates the opening degree of the startup intermediate-pressure steam governing valve V5 by feedback-control such as PID control, for example, to keep the value of the pressure gauge P1 at the target pressure. A graph 507 shows a transition of the pressure measured by the pressure gauge P2, and a graph 508 shows a transition of the pressure measured by the pressure gauge P3. Before the ST integration, the pressure of the pressure gauge P2 is high and the pressure of the pressure gauge P3 is low. Upon the ST integration, when the steam begins to flow through the system L1 and the system L9 (crossover pipe), the pressure of the pressure gauge P3 gradually increases and the pressure of the pressure gauge P2 decreases. When the pressure of the pressure gauge P3 exceeds the pressure of the pressure gauge P2, the low-pressure steam bleed valve V3 is opened and the supply of the low-pressure steam to the CO₂ capture plant is started (start of use of the normal steam system). After the low-pressure steam bleed valve V3 is opened, the pressure control of the startup intermediate-pressure steam pressure reducing valve V5 is still continued, but the valve is controlled in a direction to be closed as the inflow of the low-pressure steam increases, and when the low-pressure steam bleed valve V3 is fully open, the startup intermediate-pressure steam pressure reducing valve V5 is fully closed (graph 506). When the low-pressure steam bleed valve V3 is fully open, the control device 50 adjusts the opening degree of the CCP inlet pressure regulating valve V4 such that the pressure of the pressure gauge P2 becomes the target value (graph 505).

### Operation

The flow of the switching control of the steam supply system according to the second embodiment will be described with reference to FIG. 6. First, the control device 50 fully closes the low-pressure steam bleed valve V3, sets the opening degree of the CCP inlet pressure regulating valve V4 to a predetermined fixed opening degree, and controls the opening degree of the startup intermediate-pressure steam pressure reducing valve V5 such that the pressure measured by the pressure gauge P1 becomes a predetermined target value (step S1). In this state, GTCC startup is initiated. The control device 50 determines whether or not the pressure measured by the pressure gauge P3 exceeds the pressure measured by the pressure gauge P2 while monitoring the values measured by the pressure gauges P1 to P4 (step S4). In a case where the pressure measured by the pressure gauge P3 is equal to or less than the pressure measured by the pressure gauge P2 (step S4; No), the control device 50 continues the control in step S1. When the pressure measured by the pressure gauge P3 exceeds the pressure measured by the pressure gauge P2 (step S4; Yes), the control device 50 controls the opening degree of the low-pressure steam bleed valve V3 to be fully open (step S5). The control device 50 opens the low-pressure steam bleed valve V3 in a fully closed state at, for example, a constant speed. The control device 50 determines whether or not the low-pressure steam bleed valve V3 is fully open (step S6). When the low-pressure steam bleed valve V3 is fully open (step S6; Yes), the control device 50 controls the startup intermediate-pressure steam pressure reducing valve V5 to be fully closed (step S7). The control device 50 gradually closes the startup intermediate-pressure steam pressure reducing valve V5 to fully close the startup intermediate-pressure steam pressure reducing valve V5. In parallel with step S7, the control device 50 controls the opening degree of the CCP inlet pressure regulating valve V4 such that the pressure measured by the pressure gauge P2 becomes a predetermined target value (step S8).

### Effects

According to the second embodiment, the system for supplying the steam to the CO2 capture plant 40 can be switched from the startup intermediate-pressure bleed system L10 to the low-pressure steam bleed system. The steam supply pressure is maintained even during the switching, and a transient decrease in the steam supply flow rate can be prevented.

### Third Embodiment

In the control described in the second embodiment, the low-pressure steam bleed valve V3 is opened in a case where the pressure before and after the low-pressure steam bleed valve V3 satisfies a condition of pressure measured by the pressure gauge P3>pressure measured by the pressure gauge P2. In the GTCC control in the related art, in order to regulate the pressure on the inlet side of the low-pressure turbine 33, there is a case where the low-pressure turbine bypass valve V1 is opened even after the ST integration. In this case, the steam escapes through the turbine bypass, the pressure measured by the pressure gauge P3 does not increase, and the system switching may not be completed because the above condition is not satisfied. Therefore, in the third embodiment, a pressure control setting value of the low-pressure turbine bypass valve V1 after the ST integration is set to at least a value higher than a CCP inlet pressure setting value, that is, a target value (a target value with respect to the pressure measured by the pressure gauge P1) of the pressure control of the startup intermediate-pressure steam governing valve V5. That is, in order to maintain a state where the pressure in the vicinity of the low-pressure turbine bypass valve V1 is high, the low-pressure turbine bypass valve V1 is in a state of not being opened too much. Accordingly, even after the ST integration, a certain amount or more of low-pressure steam passes through the governing valve V2, the pressure measured by the pressure gauge P3 increases, and the condition of pressure of the pressure gauge P3>pressure of the pressure gauge P2 is satisfied.

### Operation

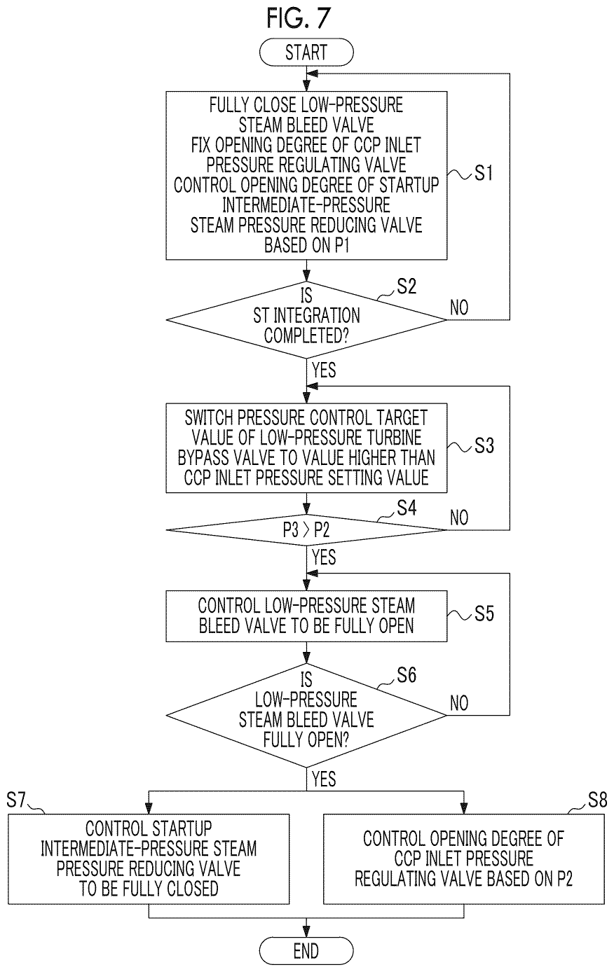

The flow of the switching control of the steam supply system according to the third embodiment will be described with reference to FIG. 7. First, the control device 50 fully closes the low-pressure steam bleed valve V3, sets the opening degree of the CCP inlet pressure regulating valve V4 to a predetermined fixed opening degree, and controls the opening degree of the startup intermediate-pressure steam pressure reducing valve V5 such that the pressure measured by the pressure gauge P1 becomes a predetermined target value (step S1). In this state, GTCC startup is initiated. Next, the control device 50 determines whether or not the operation is an operation in which the ST integration is completed (step S2). Until the ST integration is completed, the control device 50 continues the control in step S1. When the ST integration is completed (step S2; Yes), the control device 50 switches a pressure control target value of the low-pressure turbine bypass valve V1 to a value higher than the CCP inlet pressure setting value (step S3). The control device 50 controls the opening degree of the low-pressure turbine bypass valve V1 such that the pressure of the low-pressure steam flowing through the low-pressure turbine bypass valve V1 becomes a predetermined target value set to be higher than the target value set for the pressure measured by the pressure gauge P1.

Next, the control device 50 determines whether or not the pressure measured by the pressure gauge P3 exceeds the pressure measured by the pressure gauge P2 while monitoring the values measured by the pressure gauges P1 to P4 (step S4). In a case where the pressure measured by the pressure gauge P3 is equal to or less than the pressure measured by the pressure gauge P2 (step S4; No), the control device 50 continues the control in step S3. When the pressure measured by the pressure gauge P3 exceeds the pressure measured by the pressure gauge P2 (step S4; Yes), the control device 50 controls the opening degree of the low-pressure steam bleed valve V3 to be fully open (step S5), and when the low-pressure steam bleed valve V3 is fully open (step S6; Yes), the control device 50 controls the startup intermediate-pressure steam pressure reducing valve V5 to be fully closed (step S7), and controls the opening degree of the CCP inlet pressure regulating valve V4 such that the pressure measured by the pressure gauge P2 becomes a predetermined target value (step S8).

The control of the third embodiment is not limited to the example shown in FIG. 7. For example, regardless of an event such as ST integration, the pressure control setting value of the low-pressure turbine bypass valve V1 may be set to a value higher than the CCP inlet pressure setting value (target value related to P1) from the beginning. Alternatively, instead of switching the pressure control target value of the low-pressure turbine bypass valve V1, it is also conceivable to fully close the low-pressure turbine bypass valve V1. In a case where there is no limit on the pressure on the inlet side of the low-pressure turbine 33 (the pressure may be high), after the ST integration is completed, the low-pressure turbine bypass valve V1 is fully closed. In this manner, it is possible to solve a problem in that the switching is not completed because the condition of pressure of the pressure gauge P3>pressure of the pressure gauge P2 is not satisfied.

### Effects

According to the third embodiment, in addition to the effect of the second embodiment, the switching of the steam supply system is reliably completed by promoting the increase in the pressure measured by the pressure gauge P3.

### Fourth Embodiment

In the fourth embodiment, a bleed start condition of the startup intermediate-pressure steam pressure reducing valve V5 is set, and when this condition is satisfied, the startup intermediate-pressure steam pressure reducing valve V5 is opened, and the opening degree control based on the pressure measured by the pressure gauge P1 is started.

### Operation

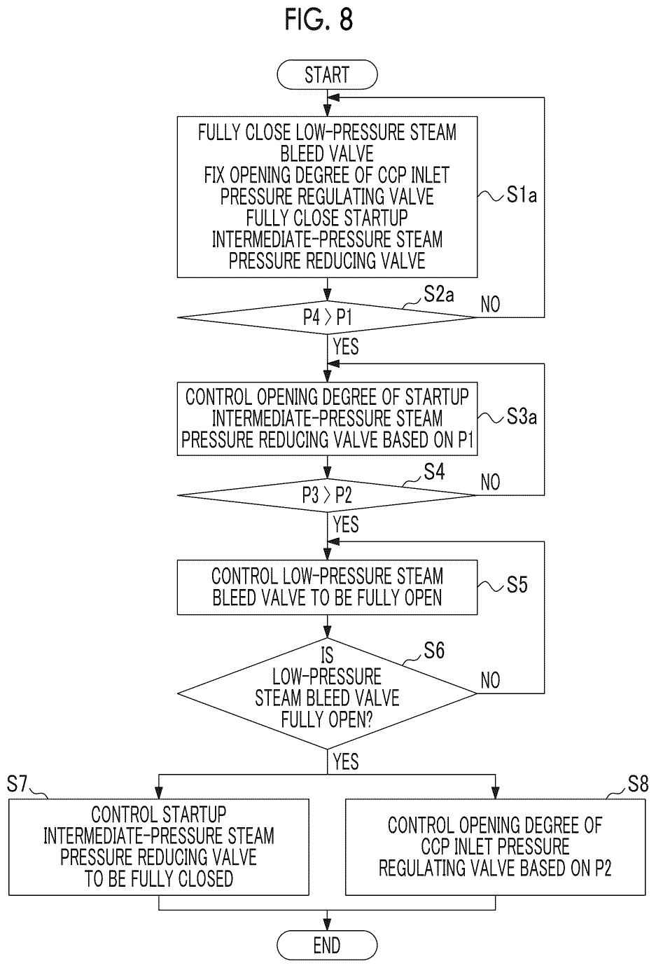

The flow of the switching control of the steam supply system according to the fourth embodiment will be described with reference to FIG. 8.

First, the control device 50 fully closes the low-pressure steam bleed valve V3, sets the opening degree of the CCP inlet pressure regulating valve V4 to a predetermined fixed opening degree, and fully closes the startup intermediate-pressure steam pressure reducing valve V5 (step S1a). In this state, GTCC startup is initiated. The control device 50 determines whether or not the pressure measured by the pressure gauge P4 exceeds the pressure measured by the pressure gauge P1 while monitoring the values measured by the pressure gauges P1 to P4 (step S2a). This condition is not satisfied during the GTCC startup, and when the generation of steam is active in the intermediate-pressure drum 25I or the like, this condition is satisfied. In a case where the pressure measured by the pressure gauge P4 is equal to or less than the pressure measured by the pressure gauge P1 (step S2a; No), the control device 50 continues the control in step S1a. When the pressure measured by the pressure gauge P4 exceeds the pressure measured by the pressure gauge P1 (step S2a; Yes), the control device 50 opens the startup intermediate-pressure steam pressure reducing valve V5 and controls the opening degree of the startup intermediate-pressure steam pressure reducing valve V5 such that the pressure measured by the pressure gauge P1 becomes a predetermined target value (step S3a). By opening the startup intermediate-pressure steam pressure reducing valve V5 after the pressure on the upstream side of the startup intermediate-pressure steam pressure reducing valve V5 becomes higher than the pressure on the downstream side, backflow or the like can be prevented.

Next, the control device 50 determines whether or not the pressure measured by the pressure gauge P3 exceeds the pressure measured by the pressure gauge P2 (step S4). In a case where the pressure measured by the pressure gauge P3 is equal to or less than the pressure measured by the pressure gauge P2 (step S4; No), the control device 50 continues the control in step S3. When the pressure measured by the pressure gauge P3 exceeds the pressure measured by the pressure gauge P2 (step S4; Yes), the control device 50 controls the opening degree of the low-pressure steam bleed valve V3 to be fully open (step S5), and when the low-pressure steam bleed valve V3 is fully open (step S6; Yes), the control device 50 controls the startup intermediate-pressure steam pressure reducing valve V5 to be fully closed (step S7), and controls the opening degree of the CCP inlet pressure regulating valve V4 such that the pressure measured by the pressure gauge P2 becomes a predetermined target value (step S8).

### Effects

According to the fourth embodiment, the bleeding is started after a pressure of a supply source of the intermediate-pressure steam is sufficiently increased, so that the backflow event can be prevented. In the above description, a case of combining with the control of the second embodiment has been described as an example. However, the fourth embodiment can be combined with the third embodiment.

### Fifth Embodiment

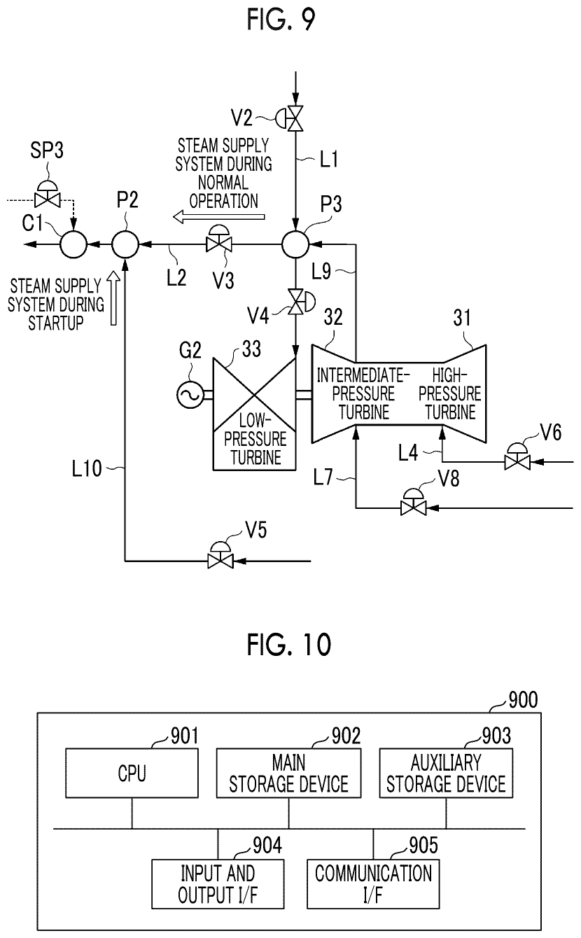

In the fifth embodiment, the position where the startup intermediate-pressure bleed system L10 and the system L2 merge is provided on an upstream side of the supply unit C1 in FIGS. 2 and 3. FIG. 9 shows a system diagram of a portion where the startup intermediate-pressure bleed system L10 and the system L2 merge. As shown in the drawing, the startup intermediate-pressure bleed system L10 is connected to a position where the pressure gauge P2 is provided. In the case of a configuration of FIGS. 2 and 3, it is necessary to provide the temperature-reducing sprays SP1 and SP2 in each of the system L2 and the system L3. However, in a case of the configuration shown in FIG. 9, for example, by providing a temperature-reducing spray SP3 in the supply unit C1, it is possible to reduce the temperature of the steam supplied to the CO₂ capture plant 40.

### Effects

According to the fifth embodiment, the number of the spray systems can be reduced from two systems to one system, and the cost of the pipe or the valve can be reduced. The configuration according to the fifth embodiment can be combined with any of the controls of the second to fourth embodiments.

As described above, according to the first to fifth embodiments, in the plant in which the GTCC and the CO₂ capture plant are combined, sufficient steam can be supplied to the CO₂ capture plant even during the GTCC startup.

FIG. 10 is a diagram showing an example of a hardware configuration of the control device according to each embodiment. A computer 900 includes a CPU 901, a main storage device 902, an auxiliary storage device 903, an input and output interface 904, and a communication interface 905. The above-described control device 50 is implemented in the computer 900. Each of the functions described above is stored in the auxiliary storage device 903 in the form of a program. The CPU 901 reads out the program from the auxiliary storage device 903, expands the program in the main storage device 902, and executes the above-described processing according to the program. The CPU 901 allocates a storage area in the main storage device 902 according to the program. The CPU 901 allocates a storage area for storing data being processed, in the auxiliary storage device 903 according to the program.

By recording a program for realizing all or some of the functions of the control device 50 on a computer-readable recording medium, and by reading the program recorded on the recording medium into a computer system and executing the read program, the processes by each functional unit may be performed. The “computer system” herein includes an OS and hardware such as peripheral devices. The “computer system” also includes a homepage providing environment (or display environment) in a case where a WWW system is used. The “computer-readable recording medium” refers to a portable medium such as a CD, a DVD, or a USB, or a storage device such as a hard disk built into the computer system. In a case where the program is distributed to the computer 900 by a communication line, the computer 900 to which the program is distributed may expand the program in the main storage device 902 and execute the processing described above. The program described above may be for realizing a part of the above functions, or may further realize the above-described functions in combination with a program already recorded in the computer system.

As described above, although some embodiments according to the present disclosure have been described, all of these embodiments are presented as examples and are not intended to limit the scope of the invention. These embodiments can be implemented in various other forms, and various omissions, replacements, and changes can be made without departing from the gist of the invention. These embodiments and variations thereof are included in the scope of the invention described in the claims and the equivalent scope thereof, as well as in the scope and gist of the invention.

### Additional Notes

The steam supply system and the steam supply method described in each embodiment are understood as follows, for example.
(1) A steam supply system according to a first aspect is a steam supply system that supplies steam generated in a heat recovery steam generator to a CO₂ capture plant 40 that captures CO₂ from exhaust gas discharged from a power generation plant (GTCC) including a gas turbine 10, the heat recovery steam generator (HRSG 20), and a steam turbine 30, the steam supply system including a first system (L10) that supplies intermediate-pressure steam generated in the heat recovery steam generator to the CO₂ capture plant; a second system (L2) that bleeds a part of low-pressure steam from a low-pressure system (L1) that supplies the low-pressure steam from the heat recovery steam generator to the steam turbine and supplies the part of the low-pressure steam to the CO₂ capture plant; and a control device 50 that performs control to supply the steam to the CO₂ capture plant through the first system during startup of the power generation plant.

Accordingly, in a plant in which the GTCC and the CO₂ capture plant are combined, sufficient steam can be supplied to the CO₂ capture plant even during GTCC startup.
(2) The steam supply system according to a second aspect is the steam supply system of (1), in which the control device 50 performs control to supply the steam to the CO₂ capture plant through the second system when the startup of the power generation plant is completed.

Accordingly, after a sufficient amount of the low-pressure steam is generated, the low-pressure steam required for the CO₂ capture plant can be supplied.
(3) The steam supply system according to a third aspect is the steam supply system of (1) to (2), in which the second system is provided with a bleed valve (V3) that is fully closed at a time of start of the startup of the power generation plant, and the control device opens the bleed valve for a predetermined time until the bleed valve is fully open when a pressure (P3) at a connection position between the low-pressure system (L1) and the second system (L2) exceeds a pressure (P2) on a downstream side of the bleed valve (V3) that is fully open in a steam flow direction in the second system.

In this manner, the low-pressure steam is supplied to the CO₂ capture plant without backflow.
(4) The steam supply system according to a fourth aspect is the steam supply system of (1) to (3), in which when the bleed valve is fully open, the control device fully closes a pressure reducing valve provided in the first system.

In this manner, the system switching from the startup intermediate-pressure bleed system to the low-pressure steam bleed system is completed.

(5) The steam supply system according to a fifth aspect is the steam supply system of (3), in which a pressure regulating valve for controlling a pressure of low-pressure steam bled by the second system is provided on a downstream side in a steam flow direction from the connection position with the second system in the low-pressure system, and the control device controls an opening degree of the pressure regulating valve such that the pressure on the downstream side of the bleed valve becomes a predetermined target value.

In this manner, the pressure of the steam required for supply to the CO₂ capture plant can be maintained (during normal operation).
(6) The steam supply system according to a sixth aspect is the steam supply system of (1) to (5), in which a pressure reducing valve is provided in the first system, and the control device controls an opening degree of the pressure reducing valve such that a pressure of the intermediate-pressure steam is reduced to a predetermined target value.

In this manner, the pressure of the steam required for supply to the CO₂ capture plant can be maintained (during the GTCC startup).
(7) The steam supply system according to a seventh aspect is the steam supply system of (6), in which the low-pressure system is connected with a bypass system that discharges the low-pressure steam by bypassing the steam turbine, and the bypass system is provided with a bypass valve, and the control device sets a target value of a pressure at a position of the bypass valve, after integration of the steam turbine, to a value higher than the predetermined target value, and controls an opening degree of the bypass valve such that the pressure at the position of the bypass valve reaches the set value.

Accordingly, even in a case where an operation is performed to open the low-pressure turbine bypass valve after ST integration, it is possible to complete the system switching from the startup intermediate-pressure bleed system to the low-pressure steam bleed system.
(8) The steam supply system according to an eighth aspect is the steam supply system of (5) and (6), in which the pressure reducing valve is fully closed when the startup of the power generation plant is started, and the control device opens the pressure reducing valve and starts controlling the opening degree of the pressure reducing valve based on the predetermined target value when a pressure on an upstream side of the pressure reducing valve in a steam flow direction exceeds a pressure on a downstream side.

By starting the bleeding after the pressure of the supply source of the intermediate-pressure steam is sufficiently increased, it is possible to prevent the backflow event.
(9) The steam supply system according to a ninth aspect is the steam supply system of (1) to (8), in which a spray for reducing a temperature of the intermediate-pressure steam is provided in the first system.

In this manner, the temperature of the intermediate-pressure steam at a relatively high temperature can be reduced.
(10) The steam supply system according to a tenth aspect is the steam supply system of (1) to (8), the system further including a third system that connects the first system and the second system at a predetermined position and supplies steam supplied through the first system and/or the second system to the CO₂ capture plant, in which a spray for reducing a temperature of the steam is provided in the third system.

In this way, the low-pressure steam temperature-reducing spray and the intermediate-pressure steam temperature-reducing spray can be combined into one, which leads to cost reduction.
(11) A steam supply method according to an eleventh aspect includes supplying intermediate-pressure steam generated in a heat recovery steam generator to a CO₂ capture plant that captures CO₂ from exhaust gas discharged from a power generation plant including a gas turbine, the heat recovery steam generator, and a steam turbine, during startup of the power generation plant, in a plant that includes the power generation plant and the CO₂ capture plant.

### Industrial Applicability

According to the steam supply system and the steam supply method described above, in the plant in which the GTCC and the CO₂ capture plant are combined, it is possible to supply sufficient steam to the CO₂ capture plant even during the GTCC startup.

### REFERENCE SIGNS LIST

100: plant
10: gas turbine
20: HRSG
21L: low-pressure economizer
21I: intermediate-pressure economizer
21H: high-pressure economizer
22L: low-pressure evaporator
22I: intermediate-pressure evaporator
22H: high-pressure evaporator
23L: low-pressure superheater
23I: intermediate-pressure superheater
23H: high-pressure superheater
24: reheater
25L: low-pressure drum
25I: intermediate-pressure drum
25H: high-pressure drum
30: steam turbine
31: high-pressure turbine
32: intermediate-pressure turbine
33: low-pressure turbine
40: CO₂ capture plant
50: control device
G1, G2: generator
P1 to P4: pressure gauge
V1: low-pressure turbine bypass valve
V2: low-pressure steam governing valve
V3: low-pressure steam bleed valve
V4: CCP inlet pressure regulating valve
V5: startup intermediate-pressure steam pressure reducing valve
V6: high-pressure main steam governing valve
V7: high-pressure turbine bypass valve
V8: intermediate-pressure steam governing valve
V9: intermediate-pressure turbine bypass valve
L1 to L11: system
900: computer
901: CPU
902: main storage device
903: auxiliary storage device
904: input and output interface
905: communication interface

1. A steam supply system that supplies steam generated in a heat recovery steam generator to a CO₂ capture plant that captures CO₂ from exhaust gas discharged from a power generation plant including a gas turbine, the heat recovery steam generator, and a steam turbine, the steam supply system comprising:
a first system that supplies intermediate-pressure steam generated in the heat recovery steam generator to the CO₂ capture plant;
a second system that bleeds a part of low-pressure steam from a low-pressure system that supplies the low-pressure steam from the heat recovery steam generator to the steam turbine and supplies the part of the low-pressure steam to the CO₂ capture plant; and
a control device that performs control to supply the steam to the CO₂ capture plant through the first system during startup of the power generation plant.
wherein the second system is provided with a bleed valve that is fully closed during start-up the startup of the power generation plant, and
the control device opens the bleed valve for a predetermined time until the bleed valve is fully open when a pressure at a connection position between the low-pressure system and the second system exceeds a pressure on a downstream side of the bleed valve in a steam flow direction in the second system.

2. The steam supply system according to claim 1,
wherein the control device performs control to supply the steam to the CO₂ capture plant through the second system when the startup of the power generation plant is completed.

3. (canceled)

4. The steam supply system according to claim 1,
wherein when the bleed valve is fully open, the control device fully closes a pressure reducing valve provided in the first system.

5. The steam supply system according to claim 1,
wherein a pressure regulating valve for controlling a pressure of low-pressure steam bled by the second system is provided on a downstream side in a steam flow direction from the connection position with the second system in the low-pressure system, and
the control device controls an opening degree of the pressure regulating valve such that the pressure on the downstream side of the bleed valve becomes a predetermined target value.

6. The steam supply system according to claim 1,
wherein a pressure reducing valve is provided in the first system, and
the control device controls an opening degree of the pressure reducing valve such that a pressure of the intermediate-pressure steam is reduced to a predetermined target value.

7. The steam supply system according to claim 6,
wherein the low-pressure system is connected with a bypass system that discharges the low-pressure steam by bypassing the steam turbine, and the bypass system is provided with a bypass valve, and
the control device sets a target value of a pressure at a position of the bypass valve, after integration of the steam turbine, to a value higher than the predetermined target value, and controls an opening degree of the bypass valve such that the pressure at the position of the bypass valve reaches the set value.

8. The steam supply system according to claim 6,
wherein the pressure reducing valve is fully closed when the startup of the power generation plant is started, and
the control device opens the pressure reducing valve and starts controlling the opening degree of the pressure reducing valve based on the predetermined target value when a pressure on an upstream side of the pressure reducing valve in a steam flow direction exceeds a pressure on a downstream side.

9. The steam supply system according to claim 1,
wherein a spray for reducing a temperature of the intermediate-pressure steam is provided in the first system.

10. The steam supply system according to claim 1, further comprising:
a third system that connects the first system and the second system at a predetermined position and supplies steam supplied through the first system and/or the second system to the CO₂ capture plant,
wherein a spray for reducing a temperature of the steam is provided in the third system.

11. A steam supply method comprising:
supplying intermediate-pressure steam generated in a heat recovery steam generator to a CO₂ capture plant that captures CO₂ from exhaust gas discharged from a power generation plant including a gas turbine, the heat recovery steam generator, and a steam turbine, during startup of the power generation plant, in a plant that includes the power generation plant, the CO₂ capture plant, a first system that supplies intermediate-pressure steam generated in the heat recovery steam generator to the CO₂ capture plant, a second system that bleeds a part of low-pressure steam from a low-pressure system that supplies the low-pressure steam from the heat recovery steam generator to the steam turbine and supplies the part of the low-pressure steam to the CO₂ capture plant, and a bleed valve provided in the second system that is fully closed during startup of the power plant,
wherein opening a bleed valve for a predetermined time until the bleed valve is fully open when a pressure at a connection position between a low-pressure system and a second system exceeds a pressure on a downstream side of the bleed valve in a steam flow direction in the second system.
